(19) United States
(12) Patent Application Publication
(10) Pub. No.: US 2006/0121335 A1
(43) Pub. Date: Jun. 8, 2006

(54) Method for Charging Nonaqueous Electrolytic Secondary Cell and Nonaqueous Electrolytic Secondary Cell

(76) Inventor: Yukitaka Seyama, Kyoto (JP)

Correspondence Address: SIDLEY AUSTIN LLP, 717 NORTH HARWOOD, SUITE 3400, DALLAS, TX, 75201, US

(21) Appl. No.: 10/532,945

(22) PCT Filed: Nov. 5, 2002
(86) PCT No.: PCT/JP02/11515

§ 371 Date: Feb. 17, 2006

(51) Int. Cl. H01M 10/44; H01M 4/50; H01M 4/58

(52) U.S. Cl. 429/50; 429/231.1; 429/224; 429/231.4

(57) ABSTRACT

A charging method of a nonaqueous electrolyte secondary battery which comprises a positive electrode plate including a lithium-manganese composite oxide with spinel structure; a negative electrode plate including graphite capable of storing and discharging lithium; and nonaqueous electrolyte. When the ratio of a theoretical capacity of the negative electrode plate to a theoretical capacity of the positive electrode plate is set as RN/s and the graphite which has stored lithium by charging is represented by LiₓC₆, the nonaqueous electrolyte secondary battery is characteristically charged so that the maximum value Xmax X can have satisfies the following Conditions (1) and (2):
Xmax≦0.75 Condition (1)
Xmax≦−0.70R_{N/S}+1.31 Condition (2) The life performance is remarkably improved by charging the nonaqueous electrolyte secondary battery while satisfying the Conditions.

### TECHNICAL FIELD

The present invention relates to a nonaqueous electrolyte secondary battery and a charging method thereof.

### BACKGROUND ART

The nonaqueous electrolyte secondary battery which has a lithium transition metal composite oxide such as lithium cobalt oxide, lithium nickelate, or lithium manganese spinel as a positive active material and a carbon material capable of storing and discharging lithium as a negative active material, is known for its excellent characteristics such as high energy density and high power. Particularly, a manganese-based nonaqueous electrolyte secondary battery which uses a lithium-manganese composite oxide with spinel structure as a positive active material is employed as a high-power power source for an electric vehicle and a hybrid electric vehicle owing to its good discharge characteristics and excellent safety, and demand for the battery is expected to further expand.

However, there is a problem in that a conventional manganese-based nonaqueous electrolyte secondary battery has an insufficient life performance.

Accordingly, 2000-228224A of the Japanese published patent application discloses a technology which improves life performance by setting the capacity ratio between positive electrode and negative electrode within a predetermined range.

However, sufficient life performance cannot be obtained even by using this technology, and further improvement of life performance has been anticipated.

The present invention has been made to address the problem mentioned above, and it is an object of the invention to further improve life performance.

### DISCLOSURE OF THE INVENTION

The inventors of the present invention devoted themselves to studies to solve such problems. As a result, it was found that a nonaqueous electrolyte secondary battery provided with a positive electrode plate including a lithium-manganese composite oxide with spinel structure and a negative electrode plate including graphite has remarkably improved life performance by charging so as to satisfy the following conditions (1) and (2):
Xmax≦0.75 Condition (1)
Xmax≦−0.70R_{N/S}+1.31 Condition (2)

It is to be noted that Xmax in Condition (1) and Condition (2) denotes the maximum value X can have when the graphite which stores lithium by charging is represented by LiₓC₆, that is, the maximum value of the charging depth.

Also, R_{N/S} denotes the ratio of the theoretical capacity of a positive electrode plate of a nonaqueous electrolyte secondary battery to the theoretical capacity of a negative electrode plate. In the present invention, examples of the lithium-manganese composite oxides with spinel structure include not only LiMn₂O₄, but also one with a part of the Mn-site of LiMn₂O₄ substituted with a metal element M other than manganese and one varied in the ratio between Li of LiMn₂O₄ and a metal element other than Li (to be described later). Although the capacity of lithium-manganese composite oxide varies in reality, the theoretical capacity of lithium-manganese composite oxide is calculated as the constant value of 148 mAh/g in the present invention. Also, the theoretical capacity of graphite is calculated as 372 mAh/g. That is, R_{N/S} is calculated as follows:
R_{N/S}={negative active material quantity inside negative electrode plate (g)×372 mAh/g}÷{positive active material quantity inside positive electrode plate (g)×148 mAh/g}

Also, Xmax is calculated in the following manner in this specification. First, a nonaqueous electrolyte secondary battery which is not charged immediately after production or a nonaqueous electrolyte secondary battery to which several cycles of discharging/charging are applied after production is charged until charge end state by a prescribed charging method in which charge current, charge voltage and charge duration and the like are set. Examples of the nonaqueous electrolyte secondary battery to which several cycles of discharging/charging are applied, include a so-called new nonaqueous electrolyte secondary battery which is available commercially and distributed to the market.

It is to be noted that when using the nonaqueous electrolyte secondary battery to which several cycles of discharging/charging are applied, the battery is charged after discharging up to the discharge end voltage of 2.75 V at 0.05 CA primarily in order to eliminate the influence of residual electricity quantity.

Next, the nonaqueous electrolyte secondary battery charged as described above, is discharged in the following discharge condition. First, a 10-minute pause is made after charging, and the battery is then discharged at a current of 1 CA up to 2.75 V to obtain discharge capacity C1. Subsequently, the battery is discharged at a current of 0.2 CA up to 2.75 V after a 10-minute pause to obtain discharge capacity C2. Subsequently, the battery is discharged at a current of 0.1 CA up to 2.75 V after a 10-minute pause to obtain discharge capacity C3. Subsequently, the battery is discharged at a current of 0.05 CA up to 2.75 V after a 10-minute pause to obtain discharge capacity C4.

It is to be noted that here, n CA such as 1 CA, 0.2 CA, 0.1 CA and 0.05 CA denotes C multiplied by n when a rated capacity value is set as C. For example, on the battery case or the like of a nonaqueous electrolyte secondary battery, a rated capacity is given as 1600 mAh in general, in which case 0.1 CA means 0.1×1600 mA, that is, discharge of 160 mA.

When the total discharge capacity of the discharge capacities C1, C2, C3 and C4 thus obtained is set to T, Xmax is calculated by the following equation. It is to be noted that Z denotes the graphite quantity (g) inside a negative electrode plate and 372 mAh/g denotes the theoretical capacity of graphite in the equation:
Xmax=T(mAh)/(Z(g)×372 mAh/g)

In the present invention, the battery is charged so as to satisfy Condition (1) and Condition (2), and various charge conditions such as charge current, charge voltage and charge duration to satisfy Condition (1) and Condition (2) vary depending on the kind of positive active material, the kind of negative active material, the kind of electrolyte or the like. Consequently, with reference to the nonaqueous electrolyte secondary battery to which the charging method of the present invention is practically applied, charge conditions such as charge current, charge voltage and charge duration which can satisfy the above conditions (1) and (2) of the present invention can be determined.

First, regarding a nonaqueous electrolyte secondary battery equivalent to the nonaqueous electrolyte secondary battery to which the charging method of the present invention is practically applied, Xmax is obtained for each charge condition in the above manner by determining plural kinds of tentative charge conditions such as charge current, charge voltage and charge duration and actually charging the battery. Then, out of the respective charge conditions, one whose Xmax satisfies the above Conditions (1) and (2) is chosen, and subsequently, a new nonaqueous electrolyte secondary battery may be charged based on that charge condition.

Next, the reason that life performance is improved when the above Condition (1) and Condition (2) are satisfied is explained. The following can be supposed: when the battery is charged so that X of the negative active material LiₓC₆ is within the range of Xmax≦0.75, preferably Xmax≦0.65 as in Condition (1), the volume change of a negative electrode plate in case of charge is suppressed with the result that collapse of the current collecting network between negative active materials due to the volume change, falling-off of negative active material from a current collector or the like is suppressed, and consequently life performance is improved. Also, when the battery is charged so that X of the negative active material LiₓC₆ is within the range of Xmax≦0.75, preferably Xmax≦0.65, electrodeposition of Li on a negative electrode rarely occurs, and life performance is improved by this also.

When using the lithium-manganese composite oxide with spinel structure as the positive active material, life performance is remarkably improved if not only Condition (1), but also Condition (2) is satisfied. The reason that life performance is improved by satisfying Condition (2) is unclear, but is presumed to be as follows. In Condition (2), since the value of X is limited by a function of R_{N/S}, which is the ratio of a negative electrode plate theoretical capacity to a positive electrode plate theoretical capacity, life performance is not improved just by a phenomenon affecting only a negative electrode plate, but by a phenomenon affecting both a positive electrode plate and a negative electrode plate.

Furthermore, the following Condition (3) is preferably satisfied in the present invention:
Xmax≧−0.45R_{N/S}+0.99 Condition (3)

This is because if this condition is satisfied, not only life performance but also energy density becomes extremely good.

It is to be noted that the range of the R_{N/S} is preferably 0.8 or more from the viewpoint of life performance.

Also, in the present invention, in any charging method of constant current/constant voltage charge, constant voltage charge and constant current charge, life performance can be improved by satisfying Condition (1) and Condition (2).

The positive electrode plate used for the nonaqueous electrolyte secondary battery in the present invention contains a lithium-manganese composite oxide with spinel structure as a positive active material. Examples of the lithium-manganese composite oxides include not only LiMn₂O₄, but also one with a part of the Mn-site of LiMn₂O₄ substituted with a metal element M other than manganese, one with varied ratio between Li of LiMn₂O₄ and a metal element other than Li, and a mixture of these. It is to be noted that the lithium-manganese composite oxide is not limited to a specific particle form, size, mixing ratio or the like. The one with a part of the Mn-site of LiMn₂O₄ substituted with a metal element M other than manganese and the one with varied ratio between Li and a metal element M other than Li, are expressed by the general formula Li₁₊ₓMn_{2-x-y}M_{y}O₄ (0≦x≦0.16, 0≦y≦0.2). Although the metal element M is not limited to a specific metal element, the metal element M preferably includes at least one chosen from Al, Cr, Ga, Y, Yb, In, Mg, Cu, Co and Ni. For the one with a part of the Mn-site substituted with a metal element M other than manganese, the life performance is remarkably improved due to its stabilized crystal structure.

Also, in the present invention, the mole ratio of lithium to a metal element other than lithium (Mn, M), that is the value of (1+x)/(2−x) in the above general formula is preferably larger than 0.5 and equal to or smaller than 0.63. This is because the crystal structure of the lithium-manganese composite oxide is stabilized by increasing the mole ratio of lithium to a metal element other than lithium (Mn, M) to exceed 0.5, and combined with the satisfactions of Condition (1) and Condition (2) in the present invention, the life performance is remarkably improved as a synergistic effect. The reason that the mole ratio is preferably 0.63 or smaller, is because if larger than 0.63, the lithium-manganese composite oxide capacity becomes impracticably too small.

It is to be noted that x or y becomes 0 in the case of either substitution of a part of the Mn-site with a metal element M or varied ratio between Li and a metal element other than Li.

Graphite as a negative active material in the present invention is not limited to a specific graphite as long as it can store and discharge lithium. The examples include natural graphite, artificial graphites such as pitch-based graphite, and a mixture of these. It is to be noted that the graphite is not limited to a specific particle form, size, mixing ratio or the like. Of these graphites, mesophase pitch-based graphite is preferably employed. This is because for the mesophase pitch-based graphite, which is one type of artificial graphite, since the orientation of the particle is small, the electrodeposition of Li is likely to occur on the negative electrode employing the mesophase pitch-based graphite with the result that the life performance is improved.

The nonaqueous electrolyte in the present invention is not particularly limited as long as it has lithium ion conductivity, and liquid, solid and gel nonaqueous electrolytes including lithium salt can be used.

Lithium salt is not limited to a specific kind, and for example, LiPF₆, LiBF₄, LiClO₄, LiAsF₆, LiCF₃SO₃, LiCF₃CF₂SO₃, LiCF₃CF₂CF₂SO₃, LiN(CF₃SO₂)₂ and LiN(C₂F₅SO₂)₂ can be used singly or by mixing two kinds or more of these.

When using liquid electrolyte, for example, ethylene carbonate, propylene carbonate, butylene carbonate, γ-butyrolactone, diethyl carbonate, dimethyl carbonate, carbonic acid esters such as ethyl methyl carbonate, sulfolane, 1,2-dimethoxyethane, 1,2-diethoxyethane, tetrahydrofuran, 2-methyl tetrahydrofuran, 3-methyl-1,3-dioxolane, methyl acetate, ethyl butyrate, methyl propionate, ethyl propionate may be used singly or by mixing two kinds or more of these.

For solid/gel nonaqueous electrolytes, inorganic solid electrolyte and polymer solid electrolyte can be employed.

In the present invention, in order to further improve life performance, nonaqueous electrolyte preferably includes a vinyl compound. Particularly, for the vinyl compound, vinylene carbonate or vinylethylene carbonate is preferably employed.

The content of a vinyl compound is not limited to a specific ratio, but 0.0004 wt % or larger to 1.5 wt % or smaller is preferable, 0.001 wt % or larger to 0.7 wt % or smaller is more preferable, and 0.03 wt % or larger to 0.3 wt % or smaller is particularly preferable based on the total weight of the nonaqueous electrolyte when a nonaqueous electrolyte secondary battery is practically used. This is because the initial internal resistance of the nonaqueous electrolyte secondary battery becomes unfavorably high when the content of a vinyl compound exceeds 1.5 wt % based on the total weight of the nonaqueous electrolyte. This is because the improvement effect on the life performance cannot be obtained by adding a vinyl compound when the content of a vinyl compound is less than 0.0004 wt % based on the total weight of the nonaqueous electrolyte. It is to be noted that since a vinyl compound decomposes along with charge/discharge of the nonaqueous electrolyte secondary battery, the concentration thereof gradually decreases. Consequently, a vinyl compound must be added so as to have a higher concentration than the above concentration when the nonaqueous electrolyte secondary battery is produced. However, since the decomposition ratio of a vinyl compound varies depending, for example, on the kind of positive active material, negative active material or the like used, the concentration of the vinyl compound when the battery is produced is experimentally obtained depending on the kind of positive active material, negative active material or the like used.

Also, as a separator of the nonaqueous electrolyte secondary battery according to the present invention, woven fabric, nonwoven fabric, fine porous synthetic resin membrane or the like can be used, and synthetic resin fine porous membranes can particularly preferably be used. Of these, fine porous polyolefin membranes such as fine porous polyethylene membrane, fine porous polypropylene membrane and fine porous membrane combination of these are preferably used because of their thickness, membrane strength, membrane resistance and the like.

It is to be noted that the nonaqueous electrolyte secondary battery of the present invention can be used in any form such as cylindrical, prismatic, sheet-type, laminated type, coin-type and pin-type, and is not restricted to a specific shape.

### BRIEF DESCRIPTION OF THE DRAWINGS

FIG. 1 is a longitudinal sectional view showing a nonaqueous electrolyte secondary battery in one embodiment of the present invention; and

FIG. 2 is a graph showing the correlation among battery performance, RN/S and charging depth X.

### BEST MODE FOR CARRYING OUT THE INVENTION

Next, the effects of the present invention will be described specifically by way of examples, but the present invention is not limited to the examples.

<Making Nonaqueous Electrolyte Secondary Battery>

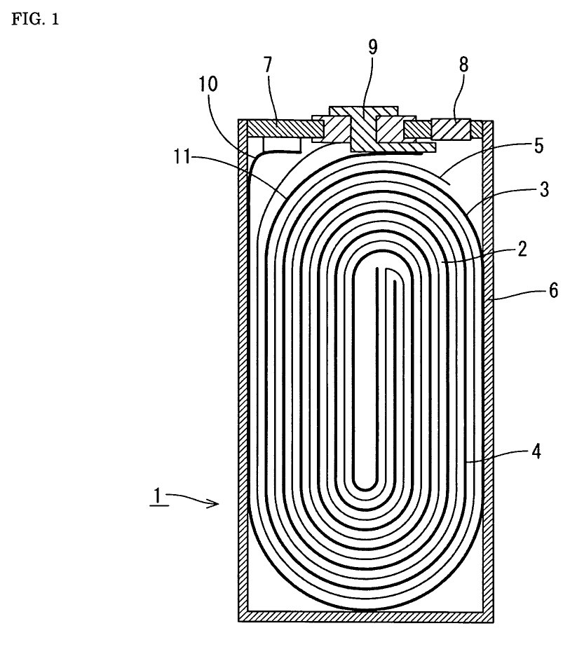

FIG. 1 is a schematic sectional view of a prismatic nonaqueous electrolyte secondary battery used in the following examples and comparative examples. The nonaqueous electrolyte secondary battery 1 is configured by housing a flat wound electrode group 2 in which a positive electrode plate 3 composed by applying positive electrode mixture to a positive electrode current collector composed of aluminum foil and a negative electrode plate 4 composed by applying negative electrode mixture to a negative electrode current collector composed of copper foil are wound through a separator 5, and nonaqueous electrolyte in a battery case 6.

A battery lid 7 having a safety valve 8 is fixed to the battery case 6 by laser welding; a negative electrode terminal 9 is connected to the negative electrode plate 4 through a negative electrode lead 11; and the positive electrode plate 3 is connected to the battery lid 7 through a positive electrode lead 10.

In the examples and comparative examples, for the nonaqueous electrolyte, 1.0 mol/liter of LiPF₆ is dissolved into a solvent in which ethylene carbonate (EC), dimethyl carbonate (DMC) and diethyl carbonate (DEC) are mixed in a volume ratio of 2:2:1 (vol %).

For the separator 5, a fine porous polyethylene film 25 micron thick was employed.

The plates in the examples and comparative examples were made as follows: First, for the positive composite mixture, 87 weight parts of LiMn₂O₄ for active material, 5 weight parts of acetylene black for conductive material and 8 weight parts of poly vinylidene fluoride for binder were mixed, dispersed by adding n-methyl-2-pyrrolidone as required, and prepared into a slurrylike form. The positive electrode plate 3 was made by evenly applying the positive composite mixture to an aluminum current collector 20 micron thick, drying and then press-forming by roll press.

For the negative electrode mixture, 94 weight parts of graphite powder and 6 weight parts of poly vinylidene fluoride were mixed, dispersed by adding n-methyl-2-pyrrolidone as required, and prepared into a slurrylike form. The negative electrode plate 4 was made by evenly applying the negative electrode mixture to a copper current collector 15 micron thick, drying and press-forming by roll press.

Then, each R_{N/S} in the examples and comparative examples was adjusted as shown in Tables 1 and 2 by changing the area ratio of the positive electrode plate and the negative electrode plate.

It is to be noted that the nonaqueous electrolyte secondary battery was designed using the above components so that its capacity would be about 400 mAh in the examples and comparative examples. Also, in the examples and comparative examples, a nonaqueous electrolyte secondary battery for cycle life test and a nonaqueous electrolyte secondary battery for measuring Xmax of the negative active material were prepared separately.

The following cycle life test is conducted for the nonaqueous electrolyte secondary battery thus made, both of the following Condition (1) and Condition (2) are satisfied in the charging method of the examples, and at least either of Condition (1) or Condition (2) is not satisfied in the charging method of the comparative examples. It is to be noted that Xmax of the negative active material shown in the following Tables 1 and 2 means the maximum value of X when the graphite which stores lithium by charge is represented by LiₓC₆, showing the value when constant current constant voltage charge finishes, that is, the maximum value in each charging method.
Xmax≦0.75 Condition (1)
Xmax≦−0.70R_{N/S}+1.31 Condition (2)

Here, a specific description is given for how to calculate Xmax. The value of Xmax was obtained by charging the nonaqueous electrolyte secondary battery prepared separately from the battery for cycle life test, which is not charged immediately after production by each charging method, then discharging to obtain its discharge capacity, and calculating from the discharge capacity.

Specifically, the battery was charged at a constant current of 400 mA and a constant voltage up to 4.10 V in an environment of 25° C. for three hours in the charging method of Examples 1-7 and Comparative Examples 1 and 2; charged at a constant current of 400 mA and a constant voltage up to 4.20 V in an environment of 25° C. for three hours in the charging method of Comparative Examples 3-11; charged at a constant current of 400 mA and a constant voltage up to 4.05 V in an environment of 25° C. for three hours in the charging method of Examples 8-13 and Comparative Examples 12 and 13; charged at a constant current of 400 mA and a constant voltage up to 4.00 V in an environment of 25° C. for three hours in the charging method of Examples 14-19 and Comparative Example 14; and charged at a constant current of 400 mA and a constant voltage up to 3.95 V in an environment of 25° C. for three hours in the charging method of Examples 20-22, and the charge was finished.

The charged nonaqueous electrolyte secondary batteries were then discharged in the following discharge conditions.

First, discharge capacity C1 was obtained by discharging at a current of 1 CA up to 2.75 V after a 10-minute pause after charging. Subsequently, discharge capacity C2 was obtained by discharging at a current of 0.2 CA up to 2.75 V after a 10-minute pause. Subsequently, discharge capacity C3 was obtained by discharging at a current of 0.1 CA up to 2.75 V after a 10-minute pause. Subsequently, discharge capacity C4 was obtained by discharging at a current of 0.05 CA up to 2.75 V after a 10-minute pause.

Setting the total discharge capacity of the discharge capacities C1, C2, C3 and C4 thus obtained as T, each Xmax was calculated by the following equation:
Xmax=T(mAh)/(Z(g)×372 mAh/g)

TABLE 1

| | | | Charge | Energy | After 500 cycles | | |
|---|---|---|---|---|---|---|---|
| | | | voltage | density | | Retention | |
| | R_{N/S} | xmax | (V) | (Wh/L) | (mAh) | (%) | Performance |
| Example 1 | 1.10 | 0.50 | 4.10 | 191 | 290.7 | 73.3 | ∘ |
| Example 2 | 1.05 | 0.53 | 4.10 | 196 | 289.5 | 71.0 | ∘ |
| Example 3 | 1.00 | 0.56 | 4.10 | 197 | 288.7 | 70.4 | ∘ |
| Example 4 | 0.95 | 0.60 | 4.10 | 203 | 272.3 | 64.6 | ∘ |
| Example 5 | 0.90 | 0.63 | 4.10 | 207 | 267.1 | 62.2 | ∘ |
| Example 6 | 0.85 | 0.68 | 4.10 | 213 | 265.8 | 60.1 | ∘ |
| Example 7 | 0.80 | 0.72 | 4.10 | 214 | 246.7 | 55.6 | ∘ |
| Comparative | 0.75 | 0.78 | 4.10 | 221 | 207.7 | 45.3 | x |
| Example 1 | | | | | | | |
| Comparative | 0.70 | 0.83 | 4.10 | 223 | 155.4 | 33.5 | x |
| Example 2 | | | | | | | |
| Comparative | 1.20 | 0.51 | 4.20 | 199 | 200.2 | 48.3 | x |
| Example 3 | | | | | | | |
| Comparative | 1.15 | 0.54 | 4.20 | 205 | 201.1 | 47.3 | x |
| Example 4 | | | | | | | |
| Comparative | 1.10 | 0.57 | 4.20 | 210 | 205.1 | 47.1 | x |
| Example 5 | | | | | | | |
| Comparative | 1.05 | 0.60 | 4.20 | 215 | 208.8 | 46.7 | x |
| Example 6 | | | | | | | |
| Comparative | 1.00 | 0.63 | 4.20 | 221 | 210.4 | 45.8 | x |
| Example 7 | | | | | | | |
| Comparative | 0.95 | 0.67 | 4.20 | 227 | 204.2 | 43.3 | x |
| Example 8 | | | | | | | |
| Comparative | 0.90 | 0.71 | 4.20 | 233 | 170.3 | 35.1 | x |
| Example 9 | | | | | | | |
| Comparative | 0.85 | 0.76 | 4.20 | 240 | 101.1 | 20.3 | x |
| Example 10 | | | | | | | |
| Comparative | 0.80 | 0.81 | 4.20 | 247 | 24.0 | 4.7 | x |
| Example 11 | | | | | | | |

TABLE 2

| | | | Charge | Energy | After 500 cycles | | |
|---|---|---|---|---|---|---|---|
| | | | voltage | density | | Retention | |
| | R_{N/S} | xmax | (V) | (Wh/L) | (mAh) | (%) | Performance |
| Example 8 | 1.00 | 0.52 | 4.05 | 183 | 296.5 | 77.9 | Δ |
| Example 9 | 0.95 | 0.55 | 4.05 | 188 | 295.3 | 75.5 | Δ |
| Example 10 | 0.90 | 0.59 | 4.05 | 194 | 294.5 | 73.1 | ∘ |
| Example 11 | 0.85 | 0.63 | 4.05 | 200 | 277.7 | 67.0 | ∘ |
| Example 12 | 0.80 | 0.67 | 4.05 | 205 | 263.3 | 61.7 | ∘ |
| Example 13 | 0.75 | 0.72 | 4.05 | 212 | 240.5 | 54.7 | ∘ |
| Comparative | 0.70 | 0.78 | 4.05 | 218 | 204.5 | 45.2 | x |
| Example 12 | | | | | | | |
| Comparative | 0.65 | 0.85 | 4.05 | 225 | 145.4 | 31.1 | x |
| Example 13 | | | | | | | |
| Example 14 | 0.95 | 0.52 | 4.00 | 176 | 302.4 | 82.6 | Δ |
| Example 15 | 0.90 | 0.55 | 4.00 | 182 | 301.2 | 79.9 | Δ |
| Example 16 | 0.85 | 0.59 | 4.00 | 187 | 300.4 | 77.4 | Δ |
| Example 17 | 0.80 | 0.63 | 4.00 | 193 | 283.3 | 70.9 | ∘ |
| Example 18 | 0.75 | 0.68 | 4.00 | 198 | 269.6 | 65.4 | ∘ |
| Example 19 | 0.70 | 0.73 | 4.00 | 205 | 245.3 | 57.8 | ∘ |
| Comparative | 0.65 | 0.80 | 4.00 | 211 | 205.3 | 46.8 | x |
| Example 14 | | | | | | | |
| Example 20 | 0.90 | 0.50 | 3.95 | 164 | 299.1 | 87.7 | Δ |
| Example 21 | 0.80 | 0.57 | 3.95 | 175 | 286.4 | 79.0 | Δ |
| Example 22 | 0.70 | 0.67 | 3.95 | 186 | 234.1 | 60.7 | Δ |

<Cycle Life Test Using the Charging Method of Examples 1-7 and Comparative Examples 1 and 2>

In the charging method of Examples 1-7 and Comparative Examples 1-2, each nonaqueous electrolyte secondary battery having the R_{N/S} value shown in Table 1 was charged at a constant current of 400 mA and a constant voltage up to 4.10 V for three hours. After a 10-minute pause, the battery was then discharged at a current of 400 mA up to 2.75 V. After discharging, a 10-minute pause was given until the next charge. This is set as one cycle, 500 cycles were executed in total, and the discharge capacity of the first cycle and the discharge capacity transition associated with the cycle were measured. It is to be noted that in one cycle of charge, pause, discharge and pause, a prescribed test temperature was maintained: the first and second cycles were executed in a test temperature of 25° C.; the third to 499^{th} cycles were executed in a test temperature of 45° C.; and the 500^{th} cycle was executed in a test temperature of 25° C. Energy density was then obtained from the discharge capacity of the second cycle. Also, retention (%), which is the ratio of the 500th cycle discharge capacity to the second cycle discharge capacity, was obtained.

<Cycle Life Test Using the Charging Method of Comparative Examples 3-11>

Energy density and retention were obtained by charging/discharging similarly to Example 1, except that the nonaqueous electrolyte secondary battery having the prescribed R_{N/S} value shown in Table 1 was employed, and that the battery was charged so that X would become the prescribed value shown in Table 1 at a charge voltage of 4.20 V.

<Cycle Life Test Using the Charging Method of Examples 8-13 and Comparative Examples 12 and 13>

Energy density and retention were obtained by charging/discharging similarly to Example 1, except that the nonaqueous electrolyte secondary battery having the prescribed R_{N/S} value shown in Table 2 was employed, and that the battery was charged so that X would become the prescribed value shown in Table 2 at a charge voltage of 4.05 V.

<Cycle Life Test Using the Charging Method of Examples 14-19 and Comparative Example 14>

Energy density and retention were obtained by charging/discharging similarly to Example 1, except that the nonaqueous electrolyte secondary battery having the prescribed R_{N/S} value shown in Table 2, and that the battery was charged so that X would become the prescribed value shown in Table 2 at a charge voltage of 4.00 V.

<Cycle Life Test Using the Charging Method of Examples 20-22>

Energy density and retention were obtained by charging/discharging similarly to Example 1, except that the nonaqueous electrolyte secondary battery having the prescribed R_{N/S} value shown in Table 2, and that the battery was charged so that X would become the prescribed value shown in Table 2 at a charge voltage of 3.95 V.

<Measurement Result>

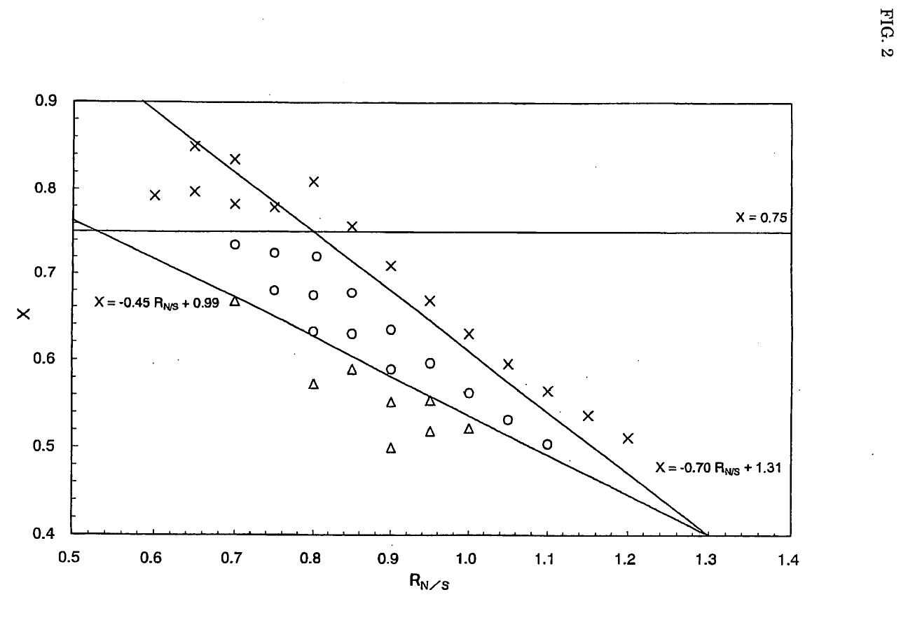

Tables 1 and 2 show the measurement result of the energy density and retention. In Tables 1 and 2, the performance of the nonaqueous electrolyte secondary battery in which the energy density is 190 Wh/L or higher and the retention is 50% or higher is shown as ∘; the performance of the nonaqueous electrolyte secondary battery in which the energy density is 190 Wh/L or lower and the retention is 50% or higher is shown as Δ; and the performance of the nonaqueous electrolyte secondary battery in which the retention is 50% or lower is shown as x. It is to be noted that FIG. 2 is a graph with R_{N/S} on the x-axis and charging depth X on the y-axis where the performances of the nonaqueous electrolyte secondary battery (∘, Δ, x) are plotted on the axes.

As shown in Tables 1 and 2 and FIG. 2, both energy density and retention were good when using the charging method of Examples 1 to 22 which satisfies both Condition (1) and Condition (2).

The reasons that life performance (retention) was improved with good energy density being maintained when Condition (1) and Condition (2) were satisfied c an be supposed as follows.

When charging so that X of the negative active material LiₓC₆ would be within the range of Condition (1), the volume change of the negative electrode plate in case of charge/discharge was suppressed, so that the collapse of the current collecting network between negative active materials due to volume change, falling-off of negative active material from the current collector or the like was suppressed, and consequently life performance was improved.

In Condition (2), since the value of X is limited by the function of R_{N/S} which is the ratio of the negative electrode plate theoretical capacity to the positive electrode plate theoretical capacity, life performance was not improved just by a phenomenon affecting the negative electrode plate, but by a phenomenon affecting both of the positive electrode plate and the negative electrode plate. Such a tendency is peculiar to a case in which a lithium-manganese composite oxide with spinel structure is employed, and the tendency is different from the cases of the tendencies of cobalt composite oxide and nickel composite oxide. Therefore, it is presumed that the phenomenon peculiar to a lithium-manganese composite oxide where manganese (Mn) eluted into the electrolyte solution affected the negative electrode plate to decrease the discharge capacity was suppressed by satisfying Condition (2) with the result that life performance was improved.

Furthermore, in Examples 1, 2, 3, 4, 5, 6, 7, 10, 11, 12, 13, 17, 18 and 19, which satisfy Condition (3) Xmax≧−0.45R_{N/S}+0.99, the energy density was 190 Wh/L or higher and it was found that a very good performance was shown.

Also, in Examples 1, 2, 3, 4, 5, 8, 9, 10, 11, 14, 15, 16, 17, 20 and 21 in which Xmax is 0.65 or smaller, retention very favorably became 62.2% or higher.

Also, in Examples 8, 9, 10, 11 and 12 in which R_{N/S} is 0.8 or more, the retention is extremely better than Example 13 in which R_{N/S} is less than 0.8; in Examples 14, 15, 16 and 17 in which R_{N/S} is 0.8 or more, the retention is extremely better than Examples 18 and 19 in which R_{N/S} is less than 0.8; and in Examples 20 and 21 in which R_{N/S} is 0.8 or more, the retention is extremely better than Example 22 in which R_{N/S} is less than 0.8. Therefore, it was found that retention was improved by increasing R_{N/S} to 0.8 or more.

### INDUSTRIAL APPLICABILITY

As described above, the charging method and the nonaqueous electrolyte secondary battery according to the present invention, when the ratio of the theoretical capacity of the negative electrode plate to the theoretical capacity of the positive electrode plate is set as R_{N/S} and the graphite which stores lithium by charging is represented by LiₓC₆ since life performance is improved by charging within the range in which the maximum value Xmax X can have satisfies Condition (1) Xmax≦0.75 and Condition (2) Xmax≦−0.70R_{N/S}+1.31, is useful in fields requiring cycle life and particularly useful for an electric vehicle and a hybrid electric vehicle.

1. A charging method of a nonaqueous electrolyte secondary battery which comprises a positive electrode plate including a lithium-manganese composite oxide with spinel structure; a negative electrode plate including graphite capable of storing and discharging lithium; and nonaqueous electrolyte, wherein:
when a ratio of a theoretical capacity of the negative electrode plate to a theoretical capacity of the positive electrode plate is set as R_{N/S} and the graphite which has stored lithium by charging is represented by LiₓC₆, the nonaqueous electrolyte secondary battery is charged so that Xmax, which is a maximum one of the value that X can be, satisfies following Conditions (1) and (2):
Xmax≦0.75 Condition (1)
Xmax≦−0.70R_{N/S}+1.31 Condition (2)

2. A charging method of the nonaqueous electrolyte secondary battery according to claim 1, wherein the Xmax further satisfies following Condition (3):
Xmax≧−0.45R_{N/S}+0.99 Condition (3)

3. A charging method of the nonaqueous electrolyte secondary battery according to either claim 1 or claim 2, wherein the Xmax is 0.65 or smaller.

4. A charging method of the nonaqueous electrolyte secondary battery according to any one of claim 1 to claim 3, wherein the R_{N/S} is 0.8 or more.

5. A charging method of the nonaqueous electrolyte secondary battery according to any one of claim 1 to claim 4, wherein a mole ratio of lithium of the lithium-manganese composite oxide to a metal element other than lithium is larger than 0.5 to 0.63 or smaller.

6. A charging method of the nonaqueous electrolyte secondary battery according to any one of claim 1 to claim 5, wherein a metal element other than manganese exists in a part of manganese site of the lithium-manganese composite oxide.

7. A charging method of the nonaqueous electrolyte secondary battery according to claim 6, wherein the metal element other than manganese includes at least one chosen from Al, Cr, Ga, Y, Yb, In, Mg, Cu, Co and Ni.

8. A charging method of the nonaqueous electrolyte secondary battery according to any one of claim 1 to claim 7, wherein the graphite includes mesophase pitch-based graphite.

9. A charging method of the nonaqueous electrolyte secondary battery according to any one of claim 1 to claim 8, wherein the nonaqueous electrolyte includes a vinyl compound.

10. A charging method of the nonaqueous electrolyte secondary battery according to claim 9, wherein the vinyl compound is either one of vinylene carbonate and vinylethylene carbonate.

11. A charging method of the nonaqueous electrolyte secondary battery according to either of claim 9 or claim 10, wherein the vinyl compound accounts for 0.0004 wt % or higher to 1.5 wt % or lower based on total weight of the nonaqueous electrolyte.

12. A nonaqueous electrolyte secondary battery which comprises a positive electrode plate including a lithium-manganese composite oxide with spinel structure; a negative electrode plate including graphite capable of storing and discharging lithium; and nonaqueous electrolyte, wherein:
when a ratio of a theoretical capacity of the negative electrode plate to a theoretical capacity of the positive electrode plate is set as R_{N/S} and the graphite which has stored lithium by charging is represented by LiₓC₆, the nonaqueous electrolyte secondary battery is charged so that Xmax, which is a maximum one of the value that X can be, satisfies following Conditions (1) and (2):
Xmax≦0.75 Condition (1)
Xmax≦−0.70R_{N/S}+1.31 Condition (2)
